(19) United States
(12) Patent Application Publication
(10) Pub. No.: US 2015/0012885 A1
(43) Pub. Date: Jan. 8, 2015

(54) TWO-MODE ACCESS LINEAR UI

(71) Applicant: DORO AB, Lund (SE)

(72) Inventors: Thomas Bergdahl, Lund (SE); Peter Cullin, Staffanstorp (SE); Yves Cammarata, Paris (FR); Maria Benktzon, Stockholm (SE); Theresa Harmanen, Kista (SE); Olof Bendt, Skarpnack (SE); Fredrik Ericsson, Nacka (SE)

(21) Appl. No.: 14/381,522

(22) PCT Filed: Feb. 26, 2013
(86) PCT No.: PCT/EP2013/053823

§ 371 Date: Aug. 27, 2014

(30) Foreign Application Priority Data
Feb. 27, 2012 (EP) 12290066.5

(51) Int. Cl. G06F 3/0484; G06F 3/0482; G06F 3/0481; G06F 3/0488; G06F 3/0485

(52) U.S. Cl. CPC G06F 3/04842; G06F 3/0488; G06F 3/0485; G06F 3/04817; G06F 3/0482
USPC 715/821

(57) ABSTRACT

A mobile telecommunication terminal has a screen and a controller which provides a graphical user interface on the screen. The user interface is capable of simultaneous provision of a plurality of selectable icons or buttons representing respective functions of the mobile telecommunication terminal. The icons are presented in at least one list, and the user interface is configured to allow scrolling of the at least one list of selectable icons to allow presentation of different parts of the list on the screen. The graphical user interface is configured to automatically switch focus from one icon which was focused in a presented part of the linearly ordered list immediately prior to application of the scroll, to another icon in the list, wherein the another icon is shown as focused at the top of the now-presented part of the list on the screen after application of the scroll.

### TECHNICAL FIELD

The present invention generally relates to the field of mobile telecommunication, and more particularly to a mobile telecommunication terminal comprising a two-part apparatus housing having first and second housing parts which are movably coupled to each other to allow operation in a first mode, with the housing parts in a first position relative to each other, and in a second mode, with the housing parts in a second position relative to each other, the first housing part comprising a touch screen and the second housing part comprising a keypad, and a controller configured to provide a graphical user interface on the touch screen, the graphical user interface being capable of simultaneous provision of a plurality of selectable icons or buttons representing respective functions of the mobile telecommunication terminal.

### BACKGROUND

Mobile telecommunication terminals come in many different brands, shapes and types, for different mobile telecommunications system like GSM, UMTS, LTE, D-AMPS, CDMA2000, FOMA or TD-SCDMA. Often, the mobile telecommunication terminals are referred to as mobile telephones, or simply mobile phones.

Whereas in the early days of mobile telecommunications, the mobile terminals were used for speech communication only, the situation has of course changed dramatically since then. Nowadays, mobile terminals are also frequently used for professional, personal and recreational services in addition to telephone calls and thus contain a plurality of application programs such as calendar, messaging, word processing, www browsing, etc.

In recent years, to increase the versatility when using such additional services, mobile terminals have been developed which are based on touch-sensitive display screens, or simply touch screens. A touch screen-based mobile terminal is often referred to as a smartphone, or alternatively a personal digital assistant (PDA), and uses a graphical user interface (GUI) for essentially all interaction with the user. Thus, thanks to the touch screen's ability to act as not only a visual output device but also as an input device for receiving commands and data from the user, the mobile terminals of today are often no longer provided with a conventional mechanical keypad like an ITU-T or PIN-type telephone keypad, or a mechanical QWERTY keyboard. Rather, such keypads or keyboards are normally implemented as virtual keypads or keyboards shown on the touch screen. To many manufacturers, this is considered as beneficial, since it allows a cost-saving from eliminating a mechanical keypad/keyboard, and it also allows the presentation area of the touch screen to be maximized and constrained essentially only by the overall size of the smartphone housing.

To access the various functions provided by a smartphone, the graphical user interface is typically configured to present a plurality of selectable icons or buttons, which represent the respective functions of the smartphone, simultaneously on the touch screen. Typically, the selectable icons are presented in a two-dimensional configuration, either as a structured grid of icons, or as an unrestricted group of icons freely (re-)positionable on the touch screen by the user—much like the desktop surface of a personal computer GUI like Microsoft Windows or Apple OS X.

However, not all user categories are comfortable with the pure smartphone-design consisting solely of a GUI on a touch screen. For instance, users which frequently need to input large amounts of text, for instance for email or word processing purposes, sometimes prefer a separate keyboard for this purpose. For instance, the Sony (Ericsson) Xperia X10 Mini Pro is provided with a miniature QWERTY keyboard which is slideable from the main part of the apparatus housing. Other examples of known mobile terminal models have been provided with an extendible ITU-T type keypad for facilitating ordinary call handling and/or input of text by way of multi-tap typing. When such an additional keyboard or keypad is pulled out, the mobile terminal automatically detects this and typically adapts/changes the GUI to prepare the terminal for use with the keyboard/keypad. This may involve rotating the view on the touch screen from portrait to landscape, or entering into a call handling application, etc.

Some drawbacks with existing approaches have been identified by inventive considerations. One such identified drawback is that the known manner of presenting a large number of selectable icons in a two-dimensional configuration on the touch screen is confusing to some (e.g. inexperienced or handicapped) user categories.

Also, the touch screen-based smart-phone approach represents a paradigm shift into a brand new user interface technology where massive amounts of information is concurrently presented on the touch screen for intended direct actuation by the user's fingertips. Far from all user groups can be expected to follow this leap without difficulties, particularly if they have been using conventional keypad-based equipment for a long time.

Even in case the smart-phone is provided with an additional keyboard or keypad, remaining drawbacks have been identified. One such drawback is that the automatic adaptation of the GUI upon extension of an additional keyboard or keypad may be contra-productive for users which may then lose track of what is going on in their mobile terminal and, in particular, make it more difficult for such users to successfully manipulate the GUI to select the appropriate icons on the touch screen.

Another such drawback is that the presence of all the extra keys on the additional keyboard or keypad may cause uncertainty to the user as to whether and to what extent the keys on the additional keyboard or keypad can or may be used for manipulating the GUI by selecting the appropriate icons on the touch screen.

Another drawback of the prior art is that a technically inapt or inexperienced user may be confused in that a display view shows an icon as selected in one situation and no icon as being selected in another situation which may be confusing to such a user. Furthermore prior art systems allow selection of an icon not being presently displayed which may also be confusing to such a user.

### SUMMARY

It is accordingly an object of the invention to eliminate or alleviate at least some of the problems referred to above.

One aspect of the present invention is a mobile telecommunication terminal comprising: a two-part apparatus housing having a first housing part movably coupled to a second housing part, the first housing part comprising a touch screen and the second housing part comprising a keypad, the mobile telecommunication terminal being operable in a first mode where the first and second housing parts assumes a first position relative to each other, and in a second mode where the first and second housing parts assumes a second position relative to each other; and a controller configured to provide a graphical user interface on said touch screen, said graphical user interface being capable of simultaneous provision of a plurality of selectable icons or buttons representing respective functions of said mobile telecommunication terminal.

According to this aspect of the present invention, the plurality of selectable icons is provided as a linearly ordered list on said touch screen; the apparatus housing has a permanently accessible actuator set for linear navigation and selection in said linearly ordered list of selectable icons; and the graphical user interface is configured such that the icons of said linearly ordered list can be navigated and selected both using said touch screen and using said actuator set in said first mode as well as in said second mode.

One more aspect of the present invention is a mobile telecommunication terminal comprising a screen and a controller configured to provide a graphical user interface on said screen, said user interface being capable of simultaneous provision of a plurality of selectable icons or buttons representing respective functions of said mobile telecommunication terminal being presented as icons in at least one list, wherein said user interface being configured to allow scrolling of the at least one list of selectable icons to allow presentation of different parts of the list on said screen, wherein the graphical user interface is configured to automatically switch focus from one icon which was focused in the presented part of the list immediately prior to application of said scroll, to another icon in the list, wherein said another icon is shown as focused at the top of the now-presented part of the list on the screen after application of said scroll.

Another aspect of the present invention is a method for use in a mobile telecommunication terminal comprising a screen and a controller configured to provide a graphical user interface on said screen, said user interface being capable of simultaneous provision of a plurality of selectable icons or buttons representing respective functions of said mobile telecommunication terminal being presented as icons in at least one list, said method comprising allowing scrolling of the at least one list of selectable icons to allow presentation of different parts of the list on said screen, automatically switching focus from one icon which was focused in the presented part of the list immediately prior to application of said scroll, to another icon in the list, and showing said another icon as focused at the top of the now-presented part of the list on the screen after application of said scroll.

This allows for a simplified and intuitive guiding of a user.

Embodiments of the invention are defined by the appended dependent claims and are further explained in the detailed description section.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Objects, features and advantages of embodiments of the invention will appear from the following detailed description, reference being made to the accompanying drawings, in which:

FIG. 1 is a schematic illustration of a non-limiting example of a telecommunication system in which embodiments of the present invention may be exercised;

FIG. 2a is a perspective front view of a mobile telecommunication terminal according to one embodiment of the present invention, the mobile telecommunication terminal being shown in a first mode in which two movably coupled housing parts are in a first, closed position relative to each other;

FIG. 2b is a perspective front view of the mobile telecommunication terminal of

FIG. 2a, here being shown in a second mode in which the two movably coupled housing parts are in a second, extended position relative to each other;

FIG. 3 is a schematic block diagram illustrating the basic internal hardware and software layout of a mobile telecommunication terminal according to an embodiment of the present invention;

FIG. 4 is a planar front view of the mobile telecommunication terminal of FIGS. 2a and 2b;

FIG. 5a is a schematic planar front view of the mobile telecommunication terminal, illustrating a triple-parameter focus indication feature according to one embodiment of the present invention;

FIG. 5b is a schematic planar front view of the mobile telecommunication terminal, illustrating a triple-parameter focus indication feature according to another embodiment of the present invention; and

FIGS. 5c-d are schematic planar front views of the mobile telecommunication terminal, illustrating an automatic scrolling icon refocus feature according to one embodiment of the present invention.

FIGS. 6a and 6b are each a perspective front view of a mobile telecommunication terminal according to one embodiment of the present invention;

FIGS. 7a-d are schematic planar front views of the mobile telecommunication terminal, illustrating an automatic scrolling icon refocus feature according to one embodiment of the present invention;

FIGS. 8a-c are schematic planar front views of the mobile telecommunication terminal, illustrating an automatic scrolling icon refocus feature for multiple lists according to one embodiment of the present invention; and

FIG. 9 shows a flowchart for a general method according to an embodiment of the present invention.

### DETAILED DESCRIPTION

Embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

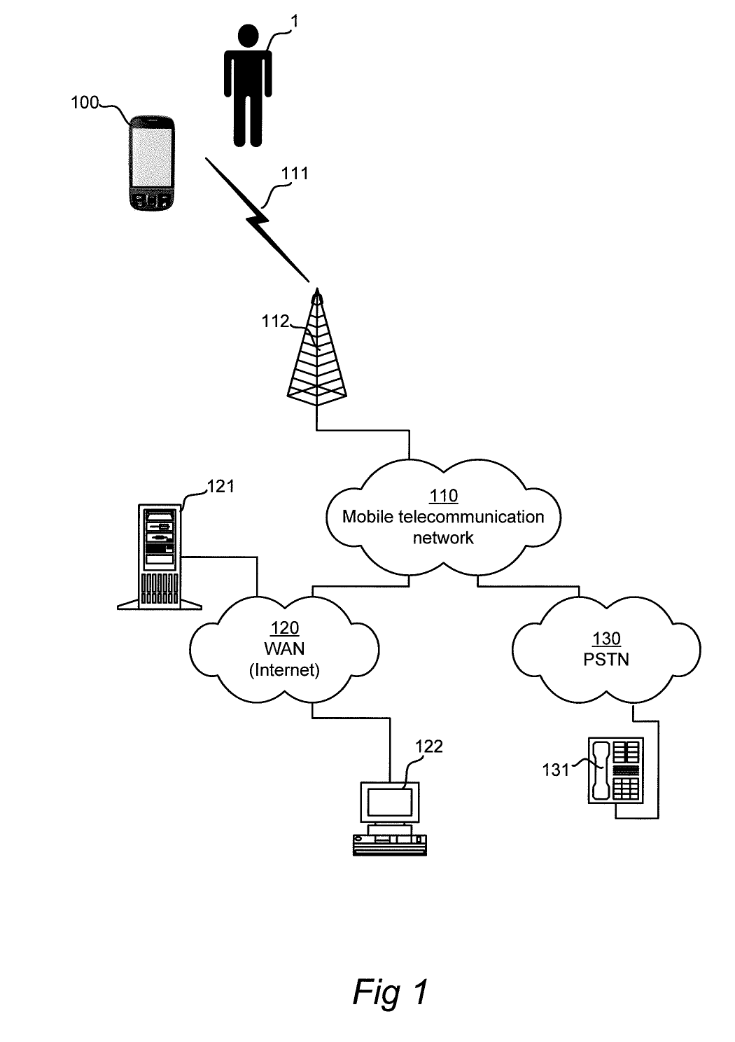

Before turning to a detailed description of the disclosed embodiments, an exemplifying environment in which they may be exercised will now be briefly described with reference to FIG. 1.

In FIG. 1, a mobile telecommunication terminal 100 is part of a cellular telecommunications system. A user 1 of the mobile telecommunication terminal 100 may use different telecommunications services, such as voice calls, Internet browsing, video calls, data calls, facsimile transmissions, still image transmissions, video transmissions, electronic messaging, and e-commerce. The invention is however not limited to any particular set of services.

The mobile telecommunication terminal 100 may connect to a mobile telecommunication network 110 over a radio link 111 and a base station 112. The mobile telecommunication terminal 100 and the mobile telecommunication network 110 may comply with any commercially available mobile telecommunication standard, for instance (without limitation) GSM, UMTS, LTE, D-AMPS, CDMA2000, FOMA and TD-SCDMA. Embodiments of the mobile telecommunication terminal 100 will be described in closer detail with reference to the following drawings.

A public switched telephone network (PSTN) 130 is connected to the mobile telecommunication network 110. Telephone terminals of PSTN subscribers may connect to the PSTN 130. In FIG. 1, a stationary telephone 131 is indicated as a mere example of this.

The mobile telecommunication network 110 is operatively associated with a wide area data network 120, which may be the Internet or a part thereof. Server computers 121 and client computers 122 may be connected to the wide area data network 120 to allow communication with the mobile telecommunication terminal 100.

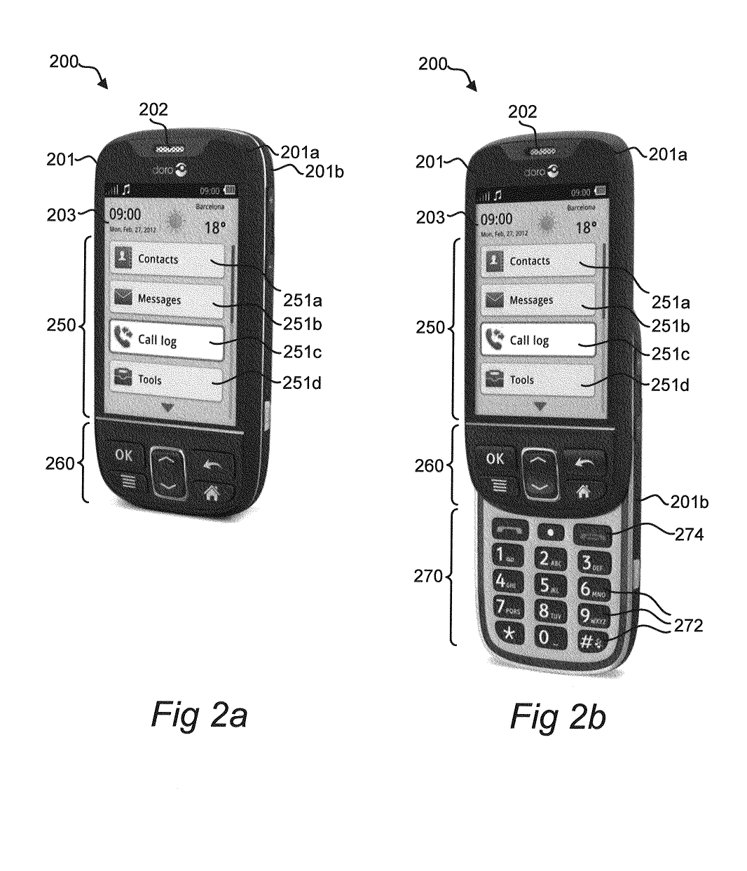

An embodiment 200 of the mobile telecommunication terminal 100 is illustrated in more detail in FIGS. 2a and 2b. The mobile telecommunication terminal 200 has a two-part apparatus housing 201 which consists of a first housing part 201 a being movably coupled to a second housing part 201b to support sliding movement between the first and second housing parts 201a, 201b. The first housing part 201a comprises a touch screen 203 at its front side. Additionally at the front side of the first housing part 201a, there is provided a permanently accessible actuator set 260 adjacently to a lower edge of the touch screen 203. The details and functions of the actuator set 260 will be described in more detail later. The second housing part 201b comprises a keypad 270.

Hence, the mobile telecommunication terminal 200 is of a sliding type which is operable in a first mode where the first and second housing parts assumes a first, closed position relative to each other (see FIG. 2a), and in a second mode where the first and second housing parts assumes a second, extended position relative to each other (see FIG. 2b). In the disclosed embodiment, the keypad 270 on the second housing part 201b comprises an ITU-T type keypad, or PIN-type keypad, which has twelve physical (mechanical) keys representing digits “0” through “9” as well as signs “*” and “#”.

In addition, the keypad 270 on the second housing part 201b comprises conventional call handling keys 274, such as physical (mechanical) off-hook and on-hook keys.

The keypad 270 is inaccessible for operation by a user 1 in the first mode where the first and second housing parts 201a, 201b assume the first, closed position relative to each other, as seen in FIG. 2a. In contrast, the keypad 270 is accessible for operation by the user 1 in the second mode where the first and second housing parts 201a, 201b assume the second, extended position relative to each other, as seen in FIG. 2b. Other kinds of keypads may be used for the keypad 270 in other embodiments.

In alternative embodiments, the mobile telecommunication terminal 200 may instead be of clamshell-type, swivel-type or generally any other type where the two housing parts 201a and 201b are movably coupled to each other.

The two-part apparatus housing 201 has a man-machine interface (MMI) which involves a loudspeaker 202, a microphone, the touch screen 203, the ITU-T-type keypad 270 and the actuator set 260.

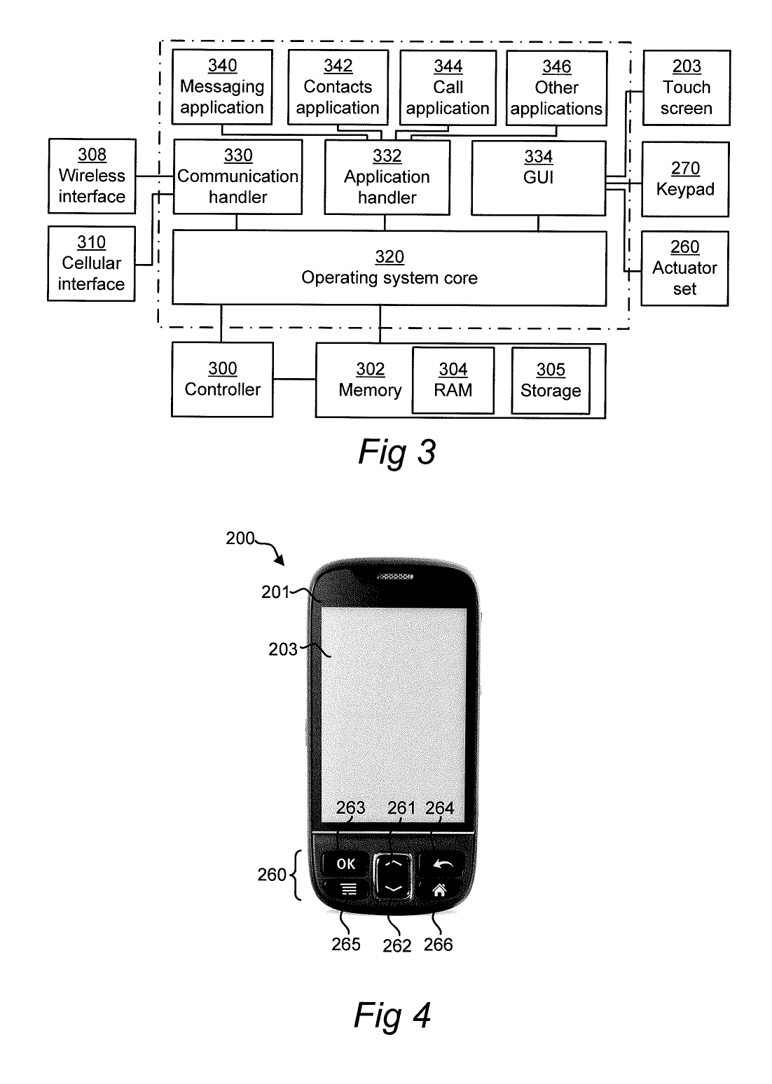

The internal software and hardware structure of the mobile terminal 200 according to an embodiment, which may or may not be the embodiment shown in FIGS. 2a and 2b, will now be described with reference to FIG. 3. Software components are indicated within a dash-dotted frame, whereas hardware components are outside of this frame. The mobile terminal 200 has a controller 300 being responsible for general device operations. Any commercially available central processing unit (CPU) or digital signal processor (DSP), or other programmable electronic logic device such as an application-specific integrated circuit (ASIC) or field-programmable gate array (FPGA), may be used to implement the controller 300. The controller 300 has associated memory 302 which includes a work memory (RAM) 304 and a non-volatile storage memory 305, for instance in the form of EEPROM, flash memory (e.g. memory card), hard disk, or any combination thereof. The controller 300 uses the memory 302 for different purposes, for instance for storing file objects as well as data and program instructions for the software in the mobile terminal 200.

The software includes an operating system core 320 on a lower level, application programs 340-346 on an upper level for interaction with the user 1, and drivers and handlers for the hardware and the application programs on an intermediate level. The intermediate level includes a GUI 334 which forms a user interface towards the user 1 by means of the touch screen 203, keypad 270 and actuator set 260.

Other I/O devices may also be included in the mobile terminal 200, such as a microphone, the loudspeaker 202, a vibrator, a ringtone generator, one or mode LED status indicators, audio volume controls, etc.

An application handler 332 controls the application programs 340-346, which may include a messaging (e.g. SMS, MMS or email) application 340, a contacts application 342, a call handling application 344 for voice calls and/or video calls, as well as various other applications 346, such as applications for browsing (e.g. www, wap), calendar, file handling, a control panel or settings application, a camera application, one or more video games, a word processing application, a spreadsheet application, a drawing application, a slideshow presentation application, etc.

The software also includes various modules, protocol stacks, drivers, etc., which are commonly designated as communication handler 330 and which provide communication support for a cellular interface 310 and, optionally, a wireless interface for Bluetooth, WLAN, NFC or IrDA (commonly designated as 308 in FIG. 3). The cellular interface 310 comprises an internal or external antenna as well as appropriate radio circuitry for establishing and maintaining a wireless link to a base station (e.g. the link 111 and base station 112 in FIG. 1). The radio circuitry comprises a radio transmitter and receiver (transceiver; TX/RX), formed for instance by band pass filters, amplifiers, mixers, local oscillators, low pass filters, AD/DA converters, etc.

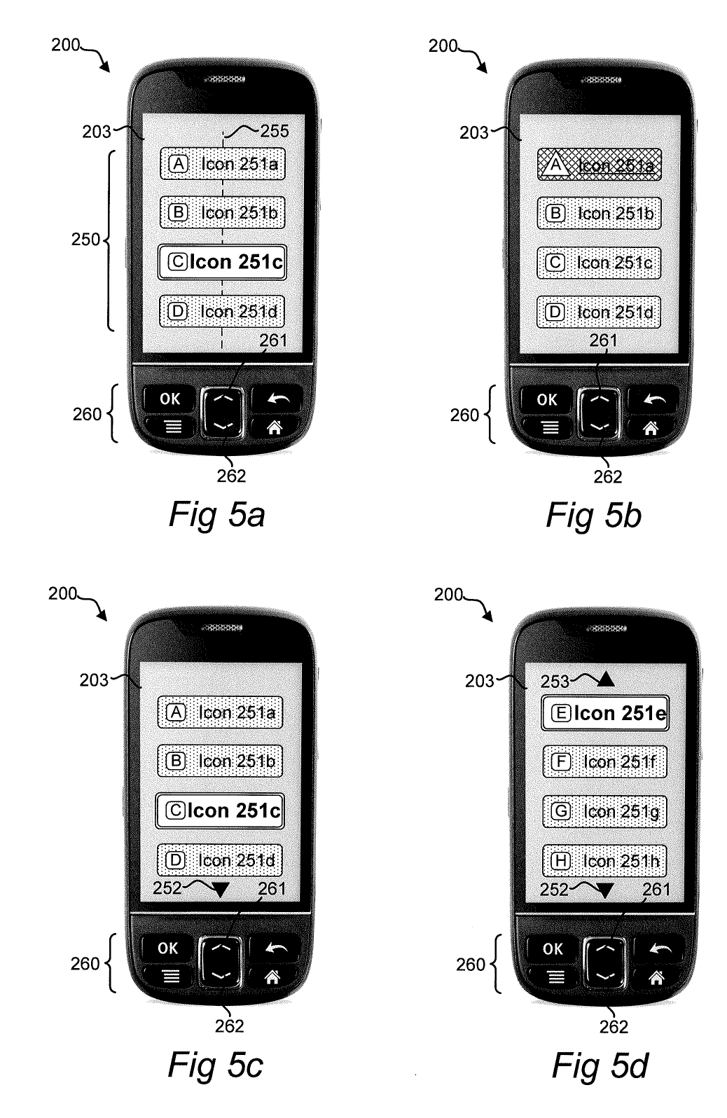

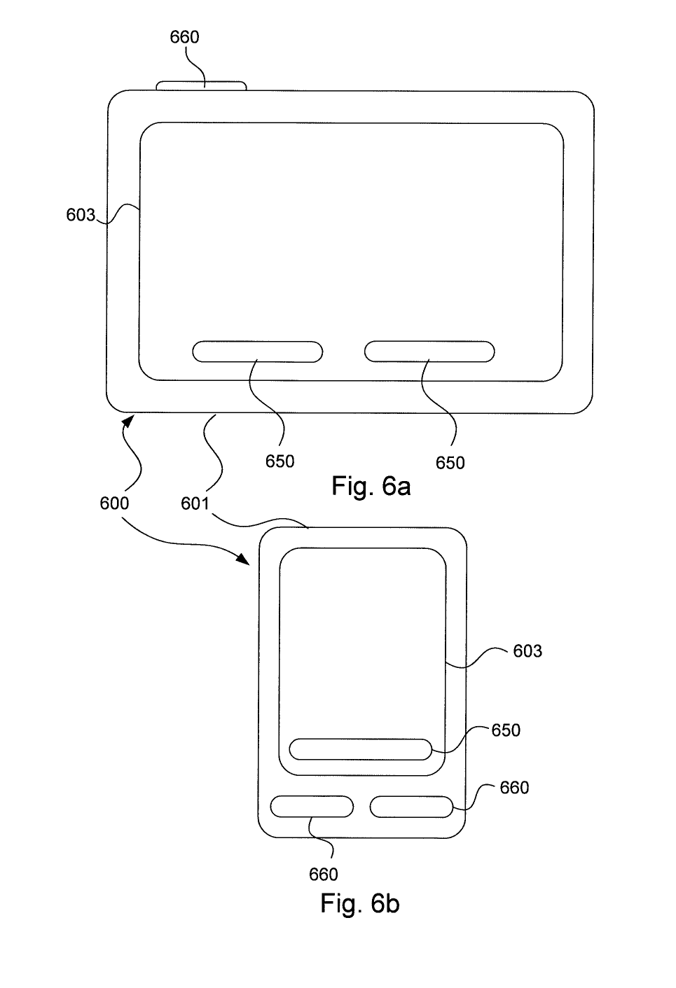

With reference to the remaining FIGS. 4 and 5a-d, an arrangement for providing a novel and inventive graphical user interface control in accordance with embodiments of the invention will now be described. As already mentioned, the controller 300 is configured to provide the graphical user interface 334 on the touch screen 203. As seen in FIGS. 5a-5d, the graphical user interface 334 is capable of simultaneous provision of a plurality of selectable icons 251a-251h or buttons representing respective functions of the mobile telecommunication terminal 300. Advantageously, the selectable icons 251a-251h will represent different ones of the application programs 340-346 as executable by the controller 300. However, the selectable icons 251a-251h may additionally or alternatively represent other selectable functions of the mobile telecommunication terminal 300, including but not limited to files or other data stored in the memory 302, or external resources 121, 122 accessible over the networks 110, 120.

Quite unlike prior art smartphone GUI:s, the plurality of selectable icons 251a-d is provided as a linearly ordered list 250 on the touch screen 203. The permanently accessible actuator set 260 is provided to allow the user 1 to perform linear navigation and selection in the linearly ordered list 250 of selectable icons. As seen in the FIG. 4 embodiment, the permanently accessible actuator set 260 comprises first and second arrow keys 261, 262 for navigating up and down, respectively, in the linearly ordered list 250 of selectable icons. In the disclosed embodiment, the first and second arrow keys 261, 262 are designed to share a common cap, which is tiltable in two directions to cause actuation of the first or second arrow key 261 or 262 as desired. The permanently accessible actuator set 260 further comprises an accept or OK key 263, a back or cancel key 264, an assistance key 265 and a home key 266. In other embodiments, the permanently accessible actuator set 260 need not comprise all of these keys 261-266, and may comprise other keys than these.

The graphical user interface 334 is configured such that the icons of the linearly ordered list 250 can be navigated and selected, in the first mode as well as in the second mode, both by using the touch screen 203 and by using the actuator set 260.

Hence, drawbacks associated with prior art approaches are avoided, since the user 1 can use exactly the same approach for navigating and selecting in the linearly ordered list 250 of icons 251a-h, irrespective of whether the terminal 200 is in the first, closed mode (FIG. 2a) or second, extended mode (FIG. 2b).

Navigating and selecting by using the touch screen 203 may involve performing gestures like dragging and tapping with one or more fingers on the surface of the touch screen 203. Navigating and selecting by using the actuator set 260 may involve pressing the up arrow key 261 and down arrow key 263 as desired to scroll in the linearly ordered list 250 of selectable icons 251a-251h, followed by selecting the desired focused icon (for instance icon 251c in FIG. 5a) by means of the accept (OK) key 263.

Advantageously, as seen in the disclosed embodiment, the first and second arrow keys are aligned with a longitudinal axis 255 of the screen surface of the touch screen 203. Likewise, the icons 251a-d of the linearly ordered list 250 are provided along the longitudinal axis 255 of the screen surface of the touch screen 203. This provides for a very accurate and intuitive navigation method also for user categories with no or limited previous experience from touch screen-based GUI:s. This advantage is emphasized by the fact that the selectable icons can only be navigated in one dimension (along the longitudinal axis 255) instead of two dimensions, as is commonplace in smartphone GUI:s.

To this end, it is preferred that the elements of the actuator set 260 which serve navigational purposes (arrow keys 261 and 262 in the disclosed embodiment) are limited to one-dimensional navigation. However, it is envisaged that other navigation elements, such as four-directional arrow keys or joysticks, may be used in alternative embodiments.

With reference to FIGS. 5a and 5b, a triple-parameter focus indication feature according to different embodiments of the present invention will now be described which gives superior guidance to inexperienced touch screen users, and/or visually impaired users.

The graphical user interface 334 is configured such that navigation of the linearly ordered list 250 using the actuator set 260 causes focus of one icon at a time. In FIG. 5a, the icon 251c is focused. The graphical user interface 334 indicates the focused icon by concurrently changing more than two appearance parameters for the focused icon 251c compared to other icons 251a, 251b, 251d in the linearly ordered list 250. Hence, the focused icon may for instance be indicated by changing three appearance parameters selected from the group consisting of: a difference in background data (such as different background color or background pattern), a difference in foreground data (such as font or symbol size, font or symbol type, font or symbol color), a border around the focused icon, and an animation of the focused icon. More than one appearance parameter may be selected from the same category.

As seen in the embodiment illustrated in FIG. 5a, the focused icon 251c is indicated by 1) a different—brighter—background color, 2) a different—larger—font size, and 3) a border around the focused icon.

On the other hand, as seen in the embodiment illustrated in FIG. 5b, the focused icon 251 a is indicated by 1) a different background pattern, 2) a different—underlined—font type, and 3) a different type for the symbol A (triangular instead of square).

With reference to FIGS. 5c-d, an automatic scrolling icon refocus feature according to one embodiment of the present invention will now be described, which gives superior guidance to inexperienced touch screen users, and/or visually impaired users.

The graphical user interface 334 is configured to allow scrolling of the linearly ordered list 250 of selectable icons 251a-251h by way of a gesture, such as a sweeping touch by the user's finger, applied onto the touch screen 203. This allows presentation of different parts of the linearly ordered list 250 on the touch screen. Small visual markers 252, 253 may assist the user 1 by indicating that there are more contents, i.e. more icons, available than is currently seen on the touch screen 203.

The graphical user interface 334 is configured to automatically switch focus from one icon (251c in FIG. 5c) which was focused in the presented part (251a-d) of the linearly ordered list immediately prior to the user's application of the gesture, to another icon (251e in FIG. 5d) in the linearly ordered list. As seen in FIG. 5c, the aforesaid another icon 251e was not in the then-presented part 251a-d of the linearly ordered list immediately before the gesture was made by the user. As seen in FIG. 5d, the aforesaid another icon is shown as focused at the top of the now-presented part 251e-251h of the linearly ordered list on the touch screen 203 after the user's application of the gesture.

The automatic scrolling icon refocus feature described with reference to FIGS. 5c-d may advantageously be combined with the triple-parameter focus indication feature described with reference to FIGS. 5a-b.

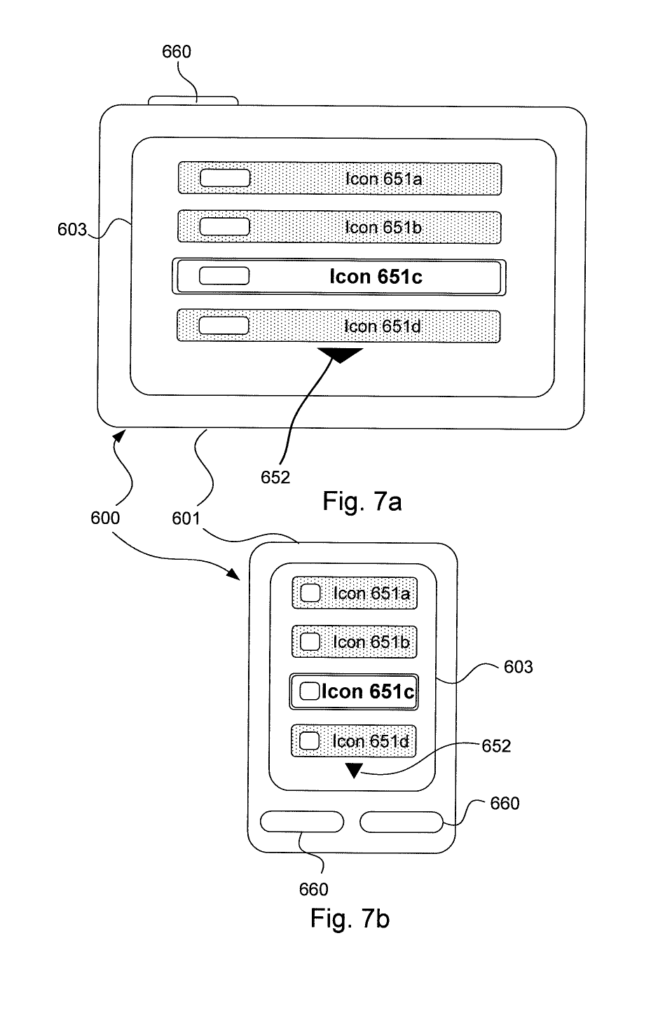

FIG. 6a shows an example of a tablet computer 600, which may or may not be an embodiment of the mobile telecommunication terminal 100. The computer tablet may be configured for wireless communication through a short range radio frequency interface such as Blutetooth® or according to the communication standard IEEE802.11 (WiFi). Alternatively or additionally the tablet computer 600 may be configured to communicate through a long range communication standard such as GSM, UMTS, LTE, D-AMPS, CDMA2000, FOMA or TD-SCDMA.

FIG. 6b shows an example of a smartphone 600 which may or may not be an embodiment of the mobile telecommunication terminal 100. The smart phone 600 may be configured for wireless communication through a long range communication standard such as GSM, UMTS, LTE, D-AMPS, CDMA2000, FOMA or TD-SCDMA. Additionally the tablet computer 600 may be configured to communicate through a short range radio frequency interface such as Blutetooth® or according to the communication standard IEEE802.11 (WiFi). Both the smartphone 600 and the tablet computer 600 will now be described jointly being referred to as a mobile communication terminal 600.

The mobile telecommunication terminal 600 has an apparatus housing 601 which comprises a touch screen 603 at its front side. Additionally there may be provided a permanently accessible actuator set 660. The mobile communication terminal 600 may or may not comprise a (mechanical) keypad, such as a QWERTY-keypad.

The apparatus housing 601 has a man-machine interface (MMI) which may involves the touch screen 603 and the actuator set 660, and alternatively a keypad (not shown), a loudspeaker (not shown), a microphone (not shown).

The internal software and hardware structure of the mobile terminal 600 according to an embodiment, which may or may not be the embodiment shown in FIGS. 6a and 6b, is similar to those described in the above with reference to FIG. 3.

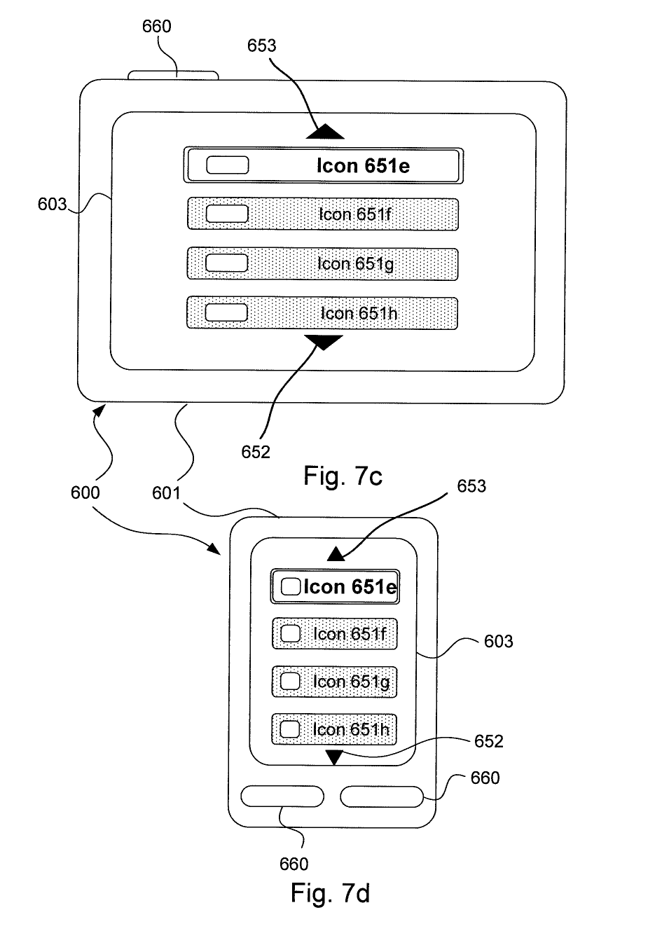

With reference to FIGS. 7a-d, an automatic scrolling icon refocus feature according to one embodiment of the present invention will now be described, which gives superior guidance to inexperienced touch screen users, and/or visually impaired users. Simultaneous reference will be given to FIGS. 7a and 7b in which an embodiment of the tablet computer and an embodiment of the smart phone are shown.

The graphical user interface 334 is configured to allow scrolling of a linearly ordered list of selectable icons 651a-651h by way of a gesture, such as a sweeping touch by the user's finger, applied onto the touch screen 603. This allows presentation of different parts of the linearly ordered list on the touch screen 603. Small visual markers 652, 653 may assist the user by indicating that there are more contents, i.e. more icons, available than is currently seen on the touch screen 603 and in which direction the list should be scrolled to reveal such more contents.

The graphical user interface is configured to automatically switch focus from one icon (651c in FIGS. 7a and 7b) which was focused in the presented part (651a-d) of the linearly ordered list immediately prior to the user's application of the gesture, to another icon (651e in FIGS. 7c and 7d) in the linearly ordered list. As seen in FIGS. 7c and 7d, the aforesaid another icon 651 e was not in the then-presented part 651a-d of the linearly ordered list immediately before the gesture was made by the user. As seen in FIGS. 7c and 7d, the aforesaid another icon is shown as focused at the top of the now-presented part 651e-651h of the linearly ordered list on the touch screen 603 after the user's application of the gesture.

In one embodiment the another icon may have been presented in the previous display as well but still being refocused to after the scrolling gesture.

In one embodiment the icon which was focused before the scrolling action will not be focused even if it is still being displayed after the scrolling action.

To always refocus after a scrolling action provides a consistency which is easy to learn and use. A user knows that after a scrolling action the focused icon will always be the one at the top of the displayed list.

The automatic scrolling icon refocus feature described with reference to FIGS. 7a-7d may advantageously be combined with the triple-parameter focus indication feature described with reference to FIGS. 5a-b.

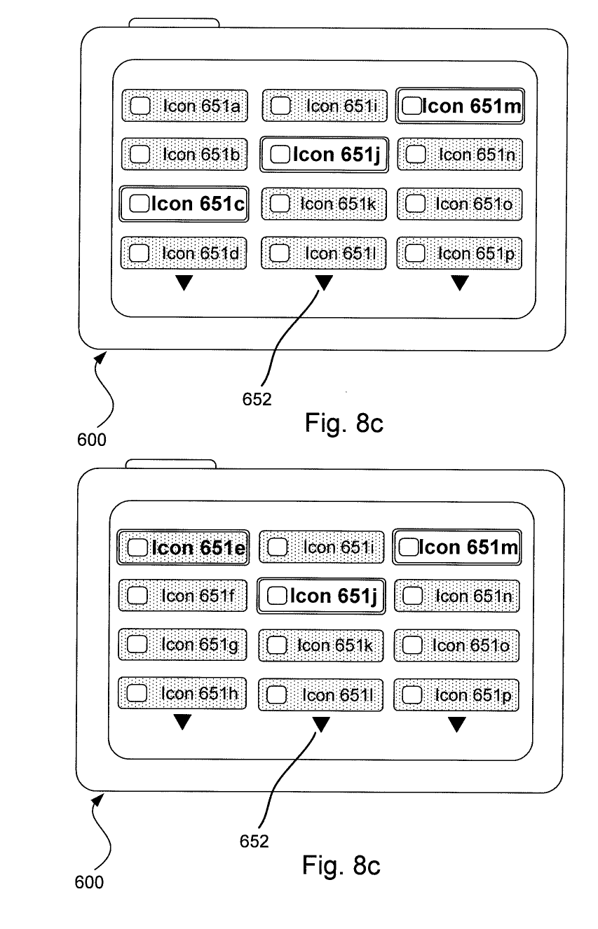

FIGS. 8a to 8c show an alternative manner of displaying a scrollable list in several columns. The manner is best suited for displays that are wide enough to display more than one icon in width. The width of the display necessary depends on the size of the icons as would be apparent to a skilled person.

As can be seen in FIG. 8a three parallel lists 651a-651d, 651i-651l and 651m-651p are displayed. Also displayed are indicators 652 to indicate that more icons are available.

In the example of FIG. 8a one icon in each list is focused. In the left list 651a-651d the icon 651c is focused, in the middle list 651i-651l the icon 651j is focused and in the right list 651m-651p the icon 651m is focused.

As can be seen in FIG. 8b, the mobile communication terminal 600 may be configured to scroll one list in response to receiving a scroll command or gesture. Such scroll command or gesture may be received through a touch gesture over the corresponding list or as a touch gesture on the associated visual indicator 652.

In such an embodiment only the corresponding list is scrolled and refocused. The refocusing may be effected in any of the manners disclosed above. In the example of FIG. 8b an icon 651 e not previously visible has been focused.

FIG. 8c shows an alternative manner of scrolling a multiple lists. In the example of FIG. 8c all three list 651a-651d, 651i-651l and 651m-651p have been scrolled and refocused. The refocusing may be effected in any of the manners disclosed above. In the example of FIG. 8c an icon 651c, 651k and 651o previously visible has been focused in each list. In this example all three lists have been scrolled an equal amount and all three lists refocused to the currently topmost displayed icon.

A multiple list scroll only having one icon indicated to be selected may also be implemented. In such an embodiment for example the top-left icon will be the one refocused to.

It should be noted that the automatic refocus feature may also be used in conjunction with a scrolling action activated by using a scrollbar. The teachings of this application may thus also be used with other scrollable (graphical) user interfaces.

As has been mentioned the automatic refocus enables a user to clearly see which feature is currently selected. It is also less confusing to a user as one selected icon will always be visible. In prior art systems, a user may be confused that the certain features are lost or at least differently marked depending on the user actions (scroll actions in particular). Also, the refocus feature removes the possibility of a user accidentally selecting an icon not even visible through the use of a (physical) select key in the actuator set 660. The refocus feature thus allows for a more intuitive and less confusing guidance of a user, especially for technically inapt users. The feature is especially beneficial when longer lists are being displayed or when the scrolling action is more than one display length.

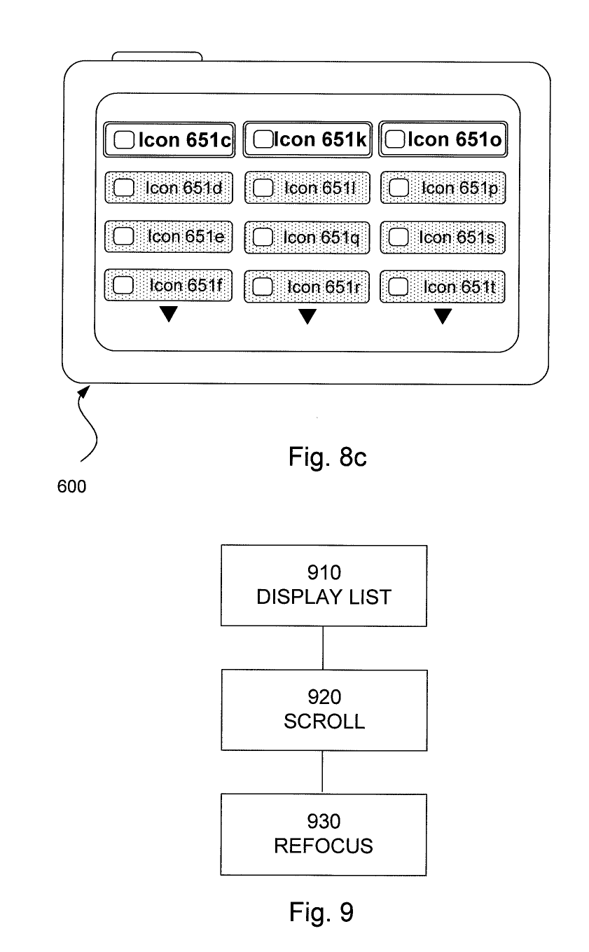

FIG. 9 shows a flowchart for a general method according to an embodiment of the present invention. A mobile telecommunication terminal 200, 600 displays 910 a list of selectable icons, the mobile communications terminal receives a scroll command and enables scrolling 920 of the list 250, 651 of selectable icons 251, 651 to allow presentation of different parts of the list 250 on said screen 603, automatically refocusing 930 switching focus from one icon 251c, 651c which was focused in the presented part 251a-d, 651a-d of the list immediately prior to application of said scroll, to another icon 251e, 651e in the list, and showing said another icon as focused at the top of the now-presented part 251e-251h, 651e-651h of the list on the screen after application of said scroll.

The invention has been described above in detail with reference to embodiments thereof. However, as is readily understood by those skilled in the art, other embodiments are equally possible within the scope of the present invention, as defined by the appended claims.

1. A mobile telecommunication terminal comprising a screen and a controller configured to provide a graphical user interface on said screen, said user interface being capable of simultaneous provision of a plurality of selectable icons or buttons representing respective functions of said mobile telecommunication terminal being presented as icons in at least one list,
wherein said user interface being configured to allow scrolling of the at least one list of selectable icons to allow presentation of different parts of the list on said screen,
wherein the graphical user interface is configured to automatically switch focus from one icon which was focused in the presented part of the list immediately prior to application of said scroll, to another icon in the list, and
wherein said another icon is shown as focused at the top of the now-presented part of the list on the screen after application of said scroll.

2. The mobile telecommunication terminal as defined in claim 1, wherein user interface is a graphical user interface.

3. The mobile telecommunication terminal as defined in claim 2, wherein screen is touch screen and said scrolling is effected by way of a gesture applied onto said touch screen.

4. The mobile telecommunication terminal as defined claim 1, wherein said list is a linearly ordered list.

5. The mobile telecommunication terminal as defined in claim 1, wherein said user interface being configured to provide a plurality of lists, said plurality of lists being displayed in parallel.

6. The mobile telecommunication terminal as defined in claim 5, wherein said scrolling is received corresponding to one list, and wherein said user interface is configured to scroll and refocus the corresponding list.

7. The mobile telecommunication terminal as defined in claim 5, wherein said scrolling is received corresponding to one list, and wherein said user interface is configured to scrolling all lists and refocus all lists.

8. The mobile telecommunication terminal as defined in claim 4, wherein said another icon was not in the then-presented part of the linearly ordered list immediately prior to application of said scroll

9. The mobile telecommunication terminal as defined in claim 4, wherein said another icon was in the then-presented part of the linearly ordered list immediately prior to application of said scroll

10. A mobile telecommunication terminal comprising:
a two-part apparatus housing having a first housing part movably coupled to a second housing part the first housing part comprising a touch screen and the second housing part comprising a keypad, the mobile telecommunication terminal being operable in a first mode where the first and second housing parts assume a first position relative to each other, and in a second mode where the first and second housing parts assume a second position relative to each other; and
a controller configured to provide a graphical user interface on said touch screen, said graphical user interface being capable of simultaneous provision of a plurality of selectable icons or buttons representing respective functions of said mobile telecommunication terminal;
wherein the plurality of selectable icons is provided as a linearly ordered list on said touch screen;
wherein the apparatus housing has a permanently accessible actuator set for linear navigation and selection in said linearly ordered list of selectable icons; and
wherein the graphical user interface is configured such that the icons of said linearly ordered list can be navigated and selected both by using said touch screen and by using said actuator set in said first mode as well as in said second mode.

11. (canceled)

12. The mobile telecommunication terminal as defined in claim 10, wherein the graphical user interface is configured such that navigation of said linearly ordered list using said actuator set causes focus of one icon at a time, said graphical user interface being capable of indicating the focused icon by concurrently changing more than two appearance parameters for the focused icon compared to other icons in said linearly ordered list.

13. The mobile telecommunication terminal as defined in claim 12, wherein the focused icon is indicated by changing three appearance parameters selected from the group consisting of:
a difference in background data, such as different background color or background pattern,
a difference in foreground data, such as different font or symbol size, font or symbol type, font or symbol color,
a border around said focused icon, and
an animation of said focused icon.

14. The mobile telecommunication terminal as defined claim 10, the graphical user interface being configured to allow scrolling of said linearly ordered list of selectable icons by way of a gesture applied onto said touch screen to allow presentation of different parts of the linearly ordered list on said touch screen, wherein the graphical user interface is configured to automatically switch focus from one icon which was focused in the presented part of the linearly ordered list immediately prior to application of said gesture, to another icon in the linearly ordered list, wherein said another icon was not in the then-presented part of the linearly ordered list immediately prior to application of said gesture and wherein said another icon is shown as focused at the top of the now-presented part of the linearly ordered list on the touch screen after application of said gesture.

15. The mobile telecommunication terminal as defined claim 10, wherein the icons of said linearly ordered list are provided along a longitudinal axis of a screen surface of said touch screen.

16. The mobile telecommunication terminal as defined in claim 10, wherein the permanently accessible actuator set comprises first and second arrow keys for navigating up and down, respectively, in said linearly ordered list of selectable icons.

17. The mobile telecommunication terminal as defined in claim 16, the icons of said linearly ordered list being provided along a longitudinal axis of a screen surface of said touch screen, wherein the first and second arrow keys are aligned with the longitudinal axis of the screen surface of said touch screen.

18. The mobile telecommunication terminal as defined in claim 16, wherein the permanently accessible actuator set further comprises an accept or OK key and a back or cancel key.

19. The mobile telecommunication terminal as defined in claim 10, the first housing part having a front side, the touch screen being provided at said front side, wherein the permanently accessible actuator set is located at said front side adjacently to an edge of said touch screen.

20. The mobile telecommunication terminal as defined in claim 10, wherein the keypad on said second housing part comprises an ITU-T type keypad.

21. The mobile telecommunication terminal as defined in claim 10, wherein said keypad is inaccessible for operation by a user in the first mode where the first and second housing parts assumes the first position relative to each other, but is accessible for operation by the user in the second mode where the first and second housing parts assumes the second position relative to each other.

22. The mobile telecommunication terminal as defined in claim 21, wherein the first and second housing parts are movably coupled to support sliding movement between the first and second housing parts.

23. The mobile telecommunication terminal as defined in claim 10, wherein the icons in said linearly ordered list of selectable icons represents different application programs executable by said controller.

24. A method for use in a mobile telecommunication terminal comprising a screen and a controller configured to provide a graphical user interface on said screen, said user interface being capable of simultaneous provision of a plurality of selectable icons or buttons representing respective functions of said mobile telecommunication terminal being presented as icons in at least one list, said method comprising
allowing scrolling of the at least one list of selectable icons to allow presentation of different parts of the list on said screen,
automatically switching focus from one icon which was focused in the a presented part of the list immediately prior to application of said scroll, to another icon in the list, and
showing said another icon as focused at the top of the now-presented part of the list on the screen after application of said scroll.
